(19) United States
(12) Patent Application Publication
(10) Pub. No.: US 2004/0256877 A1
(43) Pub. Date: Dec. 23, 2004

(54) Child safety seat sensor system and method

(76) Inventors: Gerald Alan Tromblee, Hanover, MA (US); Jeffrey Patrick Rudd, Foxboro, MA (US); Susan M. Barnabo, Walpole, MA (US); Ronald Frank, Stoughton, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/820,438

(22) Filed: Apr. 8, 2004

Related U.S. Application Data
(63) Continuation-in-part of application No. 10/761,134, filed on Jan. 20, 2004.
(60) Provisional application No. 60/461,070, filed on Apr. 8, 2003.

(51) Int. Cl. B60N 2/02

(52) U.S. Cl. 296/68.1

(57) ABSTRACT

A child safety seat sensor system and method. The sensor includes a movable member including a connection bar for connection to a device such as a child safety seat. The movable member moves relative to main plate, which is affixed to a fixed structure such as a vehicle frame. Upon connection of a child safety seat to the connection bar, tension is imparted to the movable member causing relative motion between the movable member and the main plate and an output from the sensor indicating that the seat is attached.

### CROSS-REFERENCE TO RELATED APPLICATIONS

The application is a continuation-in-part of U.S. patent application Ser. No. 10/761,134, filed Jan. 20, 2004, and claims the benefit of the filing date of U.S. Provisional Application Ser. No. 60/461,070, filed Apr. 8, 2003, the teachings of each of these applications are hereby incorporated herein by reference.

### TECHNICAL FIELD

The present invention relates generally to a sensor and system for sensing the presence of securing mechanism attached to safety attachment bar.

### BACKGROUND

New vehicles may be equipped with rigid safety bars affixed to the floor of the vehicle or assembled as an integral part of the seat between the top and bottom seat cushions. A child safety seat or other device may be equipped with a mechanism, such as an attachment bar or tether strap, to secure the seat or device to the rigid safety bar. Such a safety bar may be an ISOFIX attachment. Safety Associations around the world are requiring such safety bars to be installed in newer vehicles.

There is concern for child safety when an air bag deploys into a forward facing child safety seat. In such instances, the air bag may cause considerable harm to the front facing child. Accordingly, there is a need for a sensor that detects when a child safety seat is installed to a safety bar such as an ISOFIX attachment. Upon sensing the presence of such a child seat, a proper control signal is sent to the vehicle control system in order to limit or prevent deployment of the air bag.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a flow diagram of an exemplary system for enabling or disabling an air bag system based on the detected presence of a child safety seat;

FIG. 2 is a cross-sectional view of a safety bar attachment and exemplary sensor combination consistent with a second aspect of the present invention;

FIG. 3 and 4 illustrate in cross-sectional view a safety bar attachment and exemplary sensor combination employed in conjunction with an alternative clip mechanism;

FIG. 5 is an exploded view of an exemplary two axis tension sensor consistent with the present invention;

FIG. 6 is a perspective view of an exemplary magnetic circuit suitable for use in the exemplary sensor of FIG. 5;

FIG. 7 is a magnetic analysis of the output of exemplary sensor using Ansoft corporation Maxwell® 3D magnetic analysis software;

FIG. 8 is a perspective view of another exemplary embodiment of a sensor consistent with the present invention;

FIG. 9 is a sectional view of the sensor illustrated in FIG. 8;

FIG. 10 is an exploded view of the sensor illustrated in FIG. 8;

FIG. 11 is a bottom view of a the sensor illustrated in FIG. 8 to a fixed vehicle seat assembly via a mounting bracket consistent with the invention;

FIG. 12 is a perspective view of another exemplary embodiment of a sensor consistent with the present invention;

FIG. 13 is an exploded view of the exemplary sensor illustrated in FIG. 12;

FIG. 14 is a perspective view of a subassembly of the sensor configuration illustrated in FIG. 12;

FIG. 15 is a perspective view of the sensor assembly illustrated in FIG. 12 mounted to a fixed vehicle seat assembly;

FIG. 16 is a bottom view of the sensor assembly illustrated in FIG. 12 mounted to a mounting bracket for securing the assembly to a fixed vehicle seat assembly consistent with the invention;

FIG. 17 is a top perspective view of the sensor and mounting bracket illustrated in FIG. 16;

FIG. 18 is a schematic illustration of a magnetic circuit for use in connection with a sensor assembly consistent with the present invention;

FIG. 19 is a plot of Gauss versus magnet travel for a magnetic circuit configuration as shown for example in FIG. 18;

FIG. 20 is a schematic illustration of a sensor assembly consistent with the invention in its orientation in an exemplary seat configuration;

FIG. 21 is a plot of force versus pull angle associated with a sensor assembly consistent with the invention;

FIG. 22 is a circuit diagram of an exemplary digital sensor configuration for use in a sensor assembly consistent with the invention;

FIG. 23 is a plot of Gauss versus sensor movement associated with a digital sensor useful in a sensor assembly consistent with the invention; and

FIG. 24 is a plot of Gauss versus sensor movement for an analog sensor configuration useful in a sensor assembly consistent with the present invention.

### DETAILED DESCRIPTION

For ease of explanation, sensor systems consistent with the invention will be described herein in connection with automobile child safety seat detection systems. It will be recognized, however, a system consistent with the invention will be useful in connection with a wide variety of applications, in and out of vehicles. In addition, the exemplary embodiments described herein include use of Hall Effect sensors and a magnet. Those skilled in the art will recognize, however, that a variety of sensing means may be used. For example, optical, magneto-resistive, fluxgate sensors, etc. may be useful in connection with a sensor system consistent with the invention. In alternative embodiments, sensor control elements other than magnets or shunts, e.g. an optical source, may be used. It is to be understood, therefore, that illustrated exemplary embodiments described herein are provided only by way of illustration, and are not intended to be limiting.

According to a first aspect, the present invention is a system for disabling/enabling an air bag device for an automobile. In conjunction with a sensor that detects the engagement of a child seat into the car seat assembly, the process diagrammed allows detection of the presence of a child car seat. Based on vehicle motion, which may be detected through vehicle speed sensors and/or through position of the shift selector/transmission engagement, the passenger air bag may be dynamically disabled or enabled. In an exemplary process, a truth table is provided that allows the air bag control module to enable/disable the passenger air bag based on the dynamic interaction between the child car seat sensor, wheel speed, sensor and/or shifter select or position sensor.

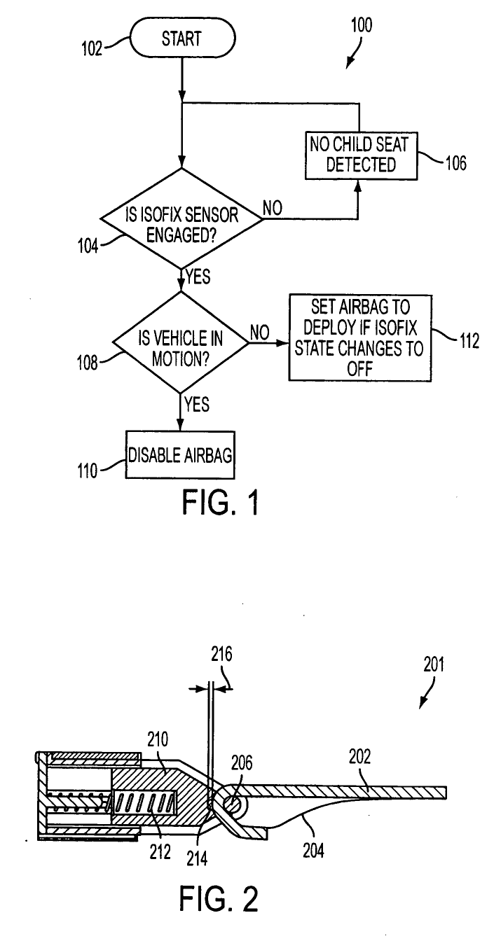

Referring to FIG. 1, a flow diagram is shown of an exemplary detection/response process 100 consistent with the first aspect of the invention. From a start point 102 that may be initiated by opening the vehicle door, turning the ignition, etc. the system first determines whether a sensor on the child seat/restraint attachment member, e.g., ISOFIX bar, is engaged (on) by a child seat/restraint attached thereto 104. If the ISOFIX sensor is not engaged (off), no child seat is detected 106 and the passenger air bag is enabled. If the ISOFIX sensor is engaged, the exemplary system evaluates whether the vehicle is in motion 108. Determining if the vehicle is in motion may be accomplished, for example, using wheel speed sensors, shifter lever position sensors, etc.

If the ISOFIX sensor is determined to be engaged, the passenger air bag is disabled 110, i.e., will not deploy once the vehicle is determined to be in motion/shifter is not in “PARK”. Even if the ISOFIX sensor becomes disengaged after vehicle motion is detected the passenger air bag will remain disabled. Furthermore, once the vehicle is in motion, if the state of the ISOFIX sensor changes from “off” to “on” the system will disable the passenger airbag. Conversely, once the vehicle is in motion, if the ISOFIX sensor changes from “on” to “off”, the passenger air bag will be enabled 112. It may be desirable to further provide a visual or audible alarm to alert the vehicle driver that the presence of a child safety seat is no longer detected. Accordingly, the system provides a dual condition fail safe. If the presence of a child seat is initially detected, but is later not detected when the vehicle is in motion, the passenger air bag will remain disabled. Similarly, if the presence of a child safety seat is not initially detected, but is later detected after the vehicle is in motion, the passenger air bag will be disabled.

After the detection/response process has been initiated, if the ISOFIX sensor is not engaged the system will either actively or passively reevaluate the condition of engagement of the ISOFIX sensor, as illustrated by the initial loop negative response loop in the flow diagram. For example, the system may remain in a “standby” mode that may be reactivated by signal resulting from the engagement of the ISOFIX sensor. At which time the system will dynamically initiate the detection response process, as illustrated in FIG. 1. Alternatively, the system may actively, either on a periodic or continuous cycle, sample the ISOFIX sensor to determine the state of engagement thereof.

It should be appreciated that the system above may be susceptible to numerous embodiments utilizing various different ISOFIX sensors and vehicle motion, or motion state, sensors. Additionally, the system may be susceptible to the use of a weight or similar sensor as the control for disabling or enabling the air bag. Similarly, the system may be adaptable to detect the presence of items other than a child safety seat, for example a cargo tie down or animal leash.

A sensor consistent with the invention may be used with a variety of clips manufactured to be used with a safety bar such an ISOFIX bar. This sensor may be used for determining the connection of a child seat latch clip to the ISOFIX bar. In one embodiment, a sensor consistent with the present invention includes a plunger tip design that can accommodate a variety of clip configurations. Turning to FIG. 2, for example, a sensor 200 is shown in a cross-sectional view in use with a first exemplary clip type 201. The first exemplary clip 201 is of a general variety including a hook shaped member 202 and a spring safety 204 configured to prevent inadvertent removal of the clip 201 from the safety bar 206 resulting from a slackening of tension on the clip 201.

The exemplary sensor 200 includes a sensor body 208 and a plunger tip 210 that may be biased toward the safety bar 206 by spring 212. Displacement of the plunger tip 210 may provide an indicating output, for example via a Hall Effect sensor having interacting components in the sensor body 208 and plunger tip 210 respectively. Various alternative plunging sensors will be apparent to those having skill in the art.

The plunger tip 210 includes a groove 214 in the distal end thereof that is adapted to contacts the ISOFIX bar 206. That is, the groove 214 allows the plunger tip 210 to be biased toward the ISOFIX bar 206 past mere tangential contact therewith. This allows some extra travel in the plunger tip 210 when a clip 201 is applied to the ISOFIX bar 206. This is important to allow detection of a relatively thin clip 201, or even a strap (not shown) to provide a robust and reliable switch function, for example between the magnet and the hall with all manufacturing tolerances.

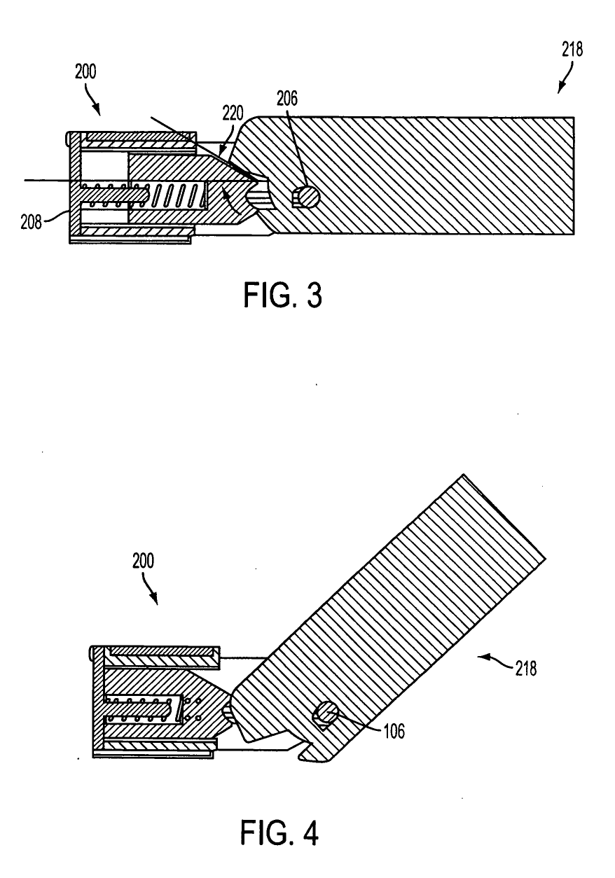

With reference to FIGS. 3 and 4, the exemplary sensor 200 is shown in use with an alternative common variety of clip 218. The second exemplary clip 218 is susceptible to rotation about the ISOFIX bar 206. The sensor according to the present invention includes an angled plunger tip 220. The angle on the plunger 220 allows easy attachment of the clip 218, as well as rotation of the clip 218 without any problems of loosing the signal or damaging the sensor 200.

It should be appreciated that the features of the above aspect of the invention are susceptible to a variety of clip styles and sensor types, as will be apparent to those having skill in the art.

A sensor consistent with the invention may also be configured as a two axis sensor, as may be applicable to use with a safety or ISOFIX bar. In such an embodiment, the sensor may provide two axis capability that may allow for 90 degrees of axis loading while still providing valid sensor output anywhere within this 90 degree range.

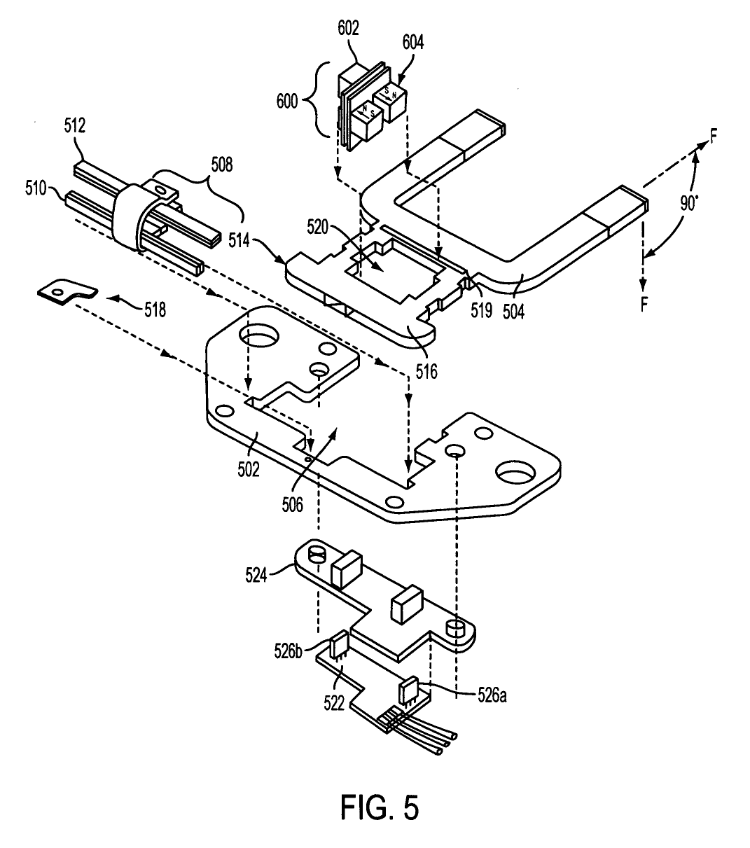

An exploded view of an exemplary sensor 500 consistent with the present invention is illustrated in FIG. 5. In the illustrated embodiment, the sensor 500 generally includes a main plate 502 and a travel plate 504. The main plate 502 includes a cutout 506 sized to receive an end portion of the travel plate 504. A leaf spring assembly 508 including two leaf springs 510, 512 arranged to receive orthogonal loading. The leaf spring assembly 508 may be received in the rear of the cutout 506, behind the travel plate 504. The two leaf springs 510, 512 act on a rear edge 514 and a perpendicular face 516. A preload spring 518 is received in the cutout 508 between the leaf spring assembly 508 and the main plate 502. Additionally, the travel plate 504 includes a pivot point 519 that may allow for out of axis movement of the travel plate 504.

The sensor 500 further includes a magnet/isolator assembly 600 received in a cutout 520 of the travel plate 504. Retained to the main plate 502 are a PCB/Hall Effect sensor assembly 522 and a protective housing 524. The PCB/Hall Effect sensor assembly 522 may include two Hall Effect sensors 526a, 526b, one each associated with each magnet set 602, 604 of the magnet/isolator assembly.

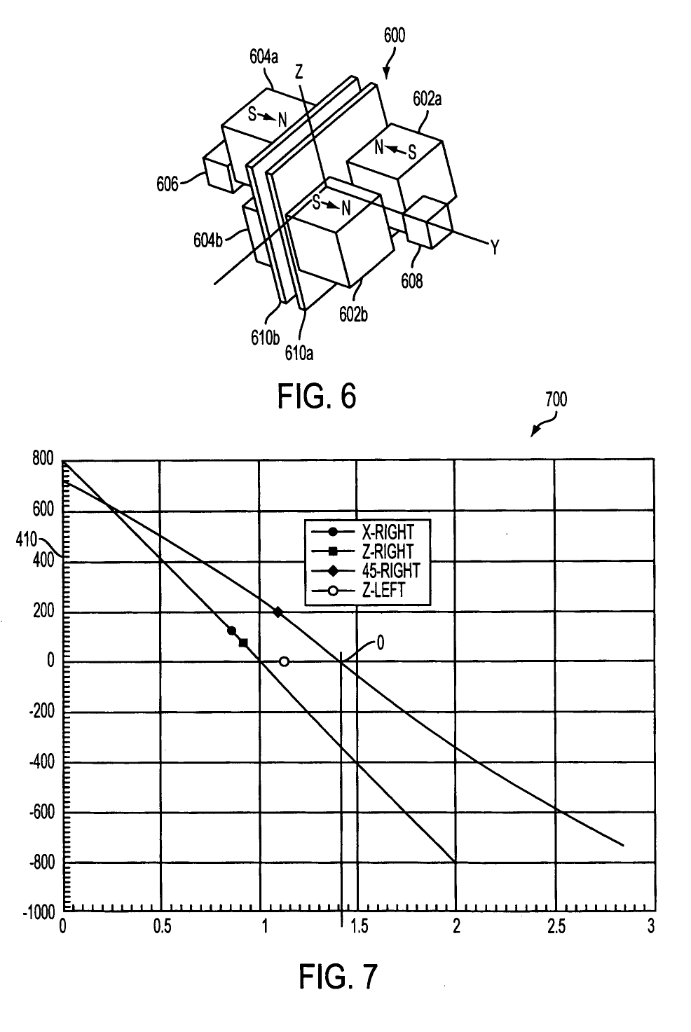

Turning to FIG. 6, an exemplary magnet/isolator assembly 600 suitable for use with the sensor 500 illustrated in FIG. 5. The exemplary magnet/isolator assembly 600 may include two magnetic circuits that are generally the same, only oriented 90 degrees relative to each other. As illustrated, the magnet/isolator assembly 600 includes two sets of magnets 602a, 602b, and 604a, 604b. The first set of magnets 602a and 602b are disposed on a first isolator plate 610a and are arranged along the X-axis in the illustration. Associated with the first set of magnets 602a, 602b is a first Hall Effect sensor 608. The first Hall Effect sensor may sense movement of the magnet/isolator assembly 600 along the X-axis. Correspondingly, disposed on the second isolator plate 610b is the second set of magnets 604a and 604b, arranged along the Y-axis. A second Hall Effect sensor 606 is associated with the second set of magnets 604a, 604b. The second Hall Effect sensor 606 may detect movement of the magnet/isolator assembly 600 along the Y-axis. The spaced apart isolator plates 610a, 610b act to isolate the two circuits magnetically, such that the magnetic field of the first set of magnets 602a, 602b does not effect the second Hall Effect sensor 606, and vice versa. In an exemplary embodiment, the isolator plates may be steel or similar structure acting to magnetically isolate the two magnetic circuits.

Consistent with the exemplary sensor 500, the magnetic circuit may be combined with separate spring loading in line with both orthogonal axes of movement. The four magnets 602a, 602b, 604a, 604b and two isolator plates 610a, 610b are mounted on the travel plate 502 move together. Any off axis movement will be provided by the pivot point 519 within the sensor housing at some minimum distance from the hall sensors. Since the sensing movement is limited, in an exemplary embodiment the movement may be in the range of about 0.040 inches, any pivoting motion of the travel plate 504 will not add any significant error to the output since the angle of movement is small and the cosine of the actual movement changes little.

An output for the exemplary sensor 500 may be derived by taking the square root of the sum of the squares of the individual hall outputs which can be accomplished electronically. Referring to FIG. 7, an attached sketch of the Ansoft Maxwell® 3D magnetic analysis results shows the output of the magnetic/shield/hall sensor configuration. The output is linear for the 1 mm range and the crosstalk from one side to the other is less than one percent.

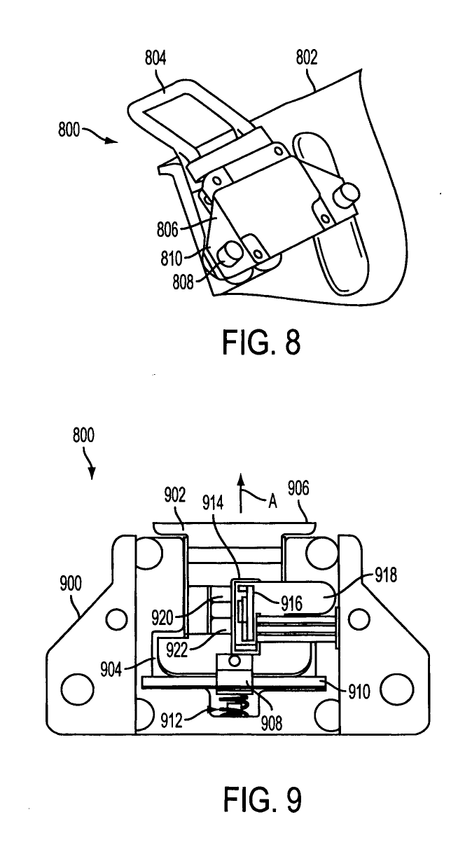

FIG. 8 is a perspective view of an exemplary sensor configuration consistent with the invention mounted to a fixed vehicle structure 802. As shown, the sensor assembly 800 includes a connection bar 804 which extends outward from a sensor body 806. The connection bar 804 may extend at an angle of approximately 30 degrees relative to the sensor bar. Of course, those skilled in the art will recognize that the angular orientation of the bar to the body may vary depending upon the application. The body may be secured to the fixed seat assembly 802 via fasteners 808 extending through mounting wings 810 of the sensor body 806.

A sectional view of the sensor assembly 800 is shown in FIG. 9. As shown, the assembly 800 may include a main plate 900 and a travel plate 902 disposed within an opening 904 of the main plate. An end 906 of the travel plate may be configured for fixedly receiving the bar 804. The travel plate 902 may be affixed to the main plate through a spring clip 908 through which one or more flat springs may extend. The ends of the flat springs 910 may rest against associated soldiers formed in the main plate. A preload spring 912 may be positioned between the main plate and the spring clip to force the flat springs against the shoulders and remove any lost motion or play between the flat springs and the main plate.

The travel plate 902 may include an opening 914 for receiving an encapsulated printed circuit board (PCB) including a Hall effect in an integrated circuit. The circuit board 916 may be fixedly attached to the main plate 904 via a tab 918. First and second magnets 920 and 922 may be fixedly secured to the main plate in opposed facing relationship to the encapsulated PCB 916.

Upon application of tension to the bar 804, the travel plate moves relative to the main plate in the direction of arrow A. As a result, relative motion occurs between the magnets 920, 922 and the PCB 916. This relative motion causes a change in the flex density imparted to the Hall IC within the PCB 916 causing an output variation.

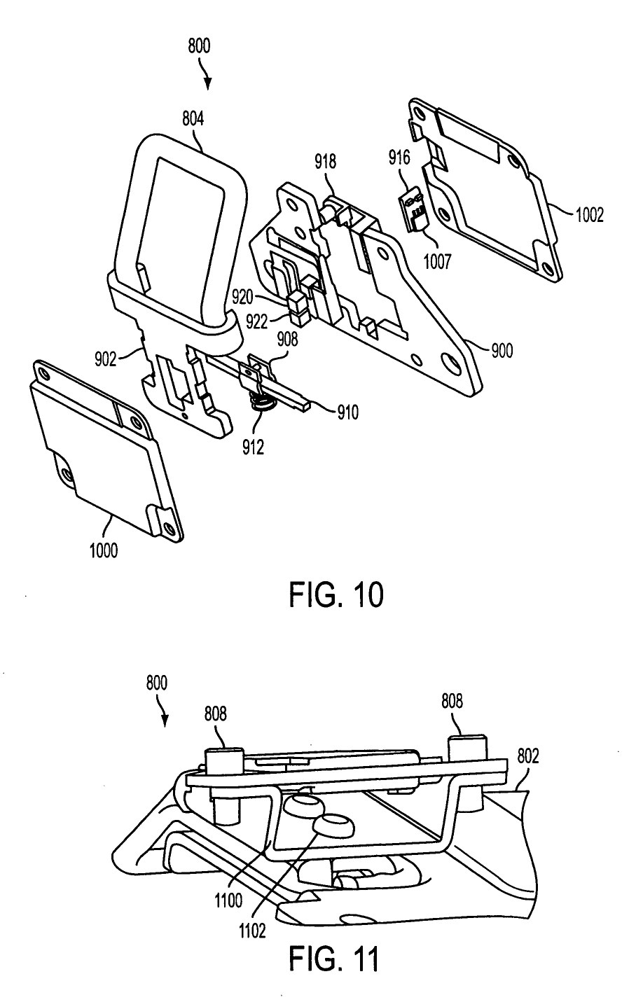

FIG. 10 is an exploded view of the assemblies illustrated in FIGS. 8 and 9 showing the orientation of a front 1000 and back 1002 cover for the assembly. FIG. 10 also more particularly illustrates the orientation of the Hall effect IC 1004 on the PCB 916.

FIG. 11 is a bottom perspective view of a sensor assembly 800 as shown in FIG. 8 affixed to a fixed vehicle seat assembly 802. In the illustrated exemplary embodiment, the sensor assembly 800 is affixed to a bracket 1100 having a tapered angular configuration. The bracket 1100 is directly affixed to the assembly 802 via fasteners 1102 and the assembly 800 is affixed to the bracket via fasteners 808. To assemble the sensor assembly 800 to the structure 802, the bracket may first be installed by fixing the bracket against the assembly 802 and securing the bracket to the assembly 802 via fasteners 1102. The sensor assembly may then be installed to the bracket via fasteners 808.

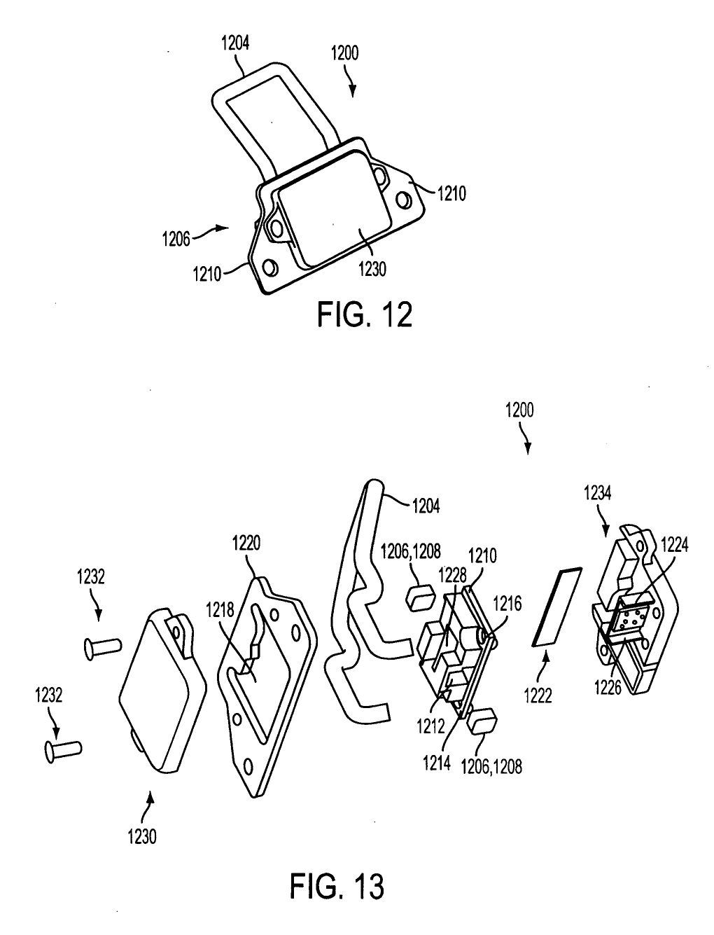

Turning now to FIG. 12, there is illustrated a perspective view of another exemplary embodiment of a sensor configuration 1200 consistent with the invention. The embodiment 1200 includes a connection bar 1204 and a body portion 1206 which may be mounted to a seat structure, e.g. 802, via fasteners through wings 1210 extending from the body portion. FIG. 13 is an exploded view of the embodiment 1200 illustrated in FIG. 12. The embodiment 1200 includes the bar 1204, magnets 1206, 1208 and a magnet holder 1210. The magnets may be assembled into openings formed in the magnet holder 1210. The magnets 1206, 1208 may be received in openings, e.g. 1212, in the magnet holder and the magnet holder may be affixed to the bar. As shown, the bar may include end portions that extend through associated openings 1214, 1216 in the magnet holder 1210.

The bar 1204, the magnet holder 1210 and the magnets 1206, 1208 thus form a movable bar assembly. The magnet holder may be sized to be received in an opening 1218 in a main plate 1220, and may be biased against the main plate via one or more flat springs 1222. A rear cover may be positioned against the magnet holder and may include a PCB fixed to an extension portion 1224. The PCB 1226 may extend into an associated opening 1228 in the magnet holder 1210. A front cover 1230 may be positioned over the assembly and may be affixed thereto by fasteners, e.g. rivets 1232, extending through openings in the front cover 1230, the main plate 1220 and the back cover 1234.

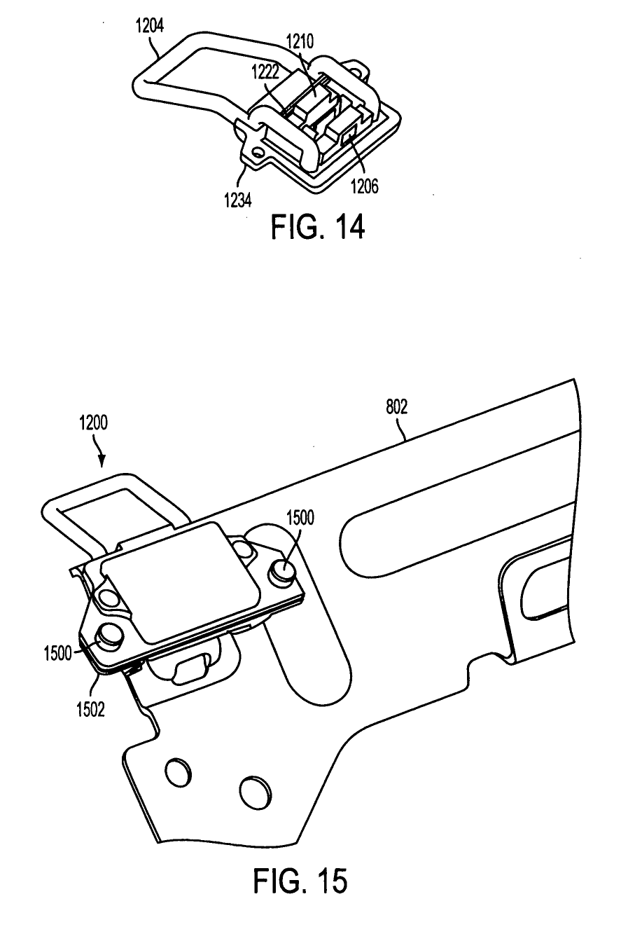

FIG. 14 is a perspective view of the movable bar assembly including the bar 1204, and the magnet holder 1210 with the rear cover 1234 affixed thereto. As shown, the flat springs 1222 may be received between the magnet holder 1210 and the rear cover to bias the movable bar assembly against the main plate and the front and rear covers.

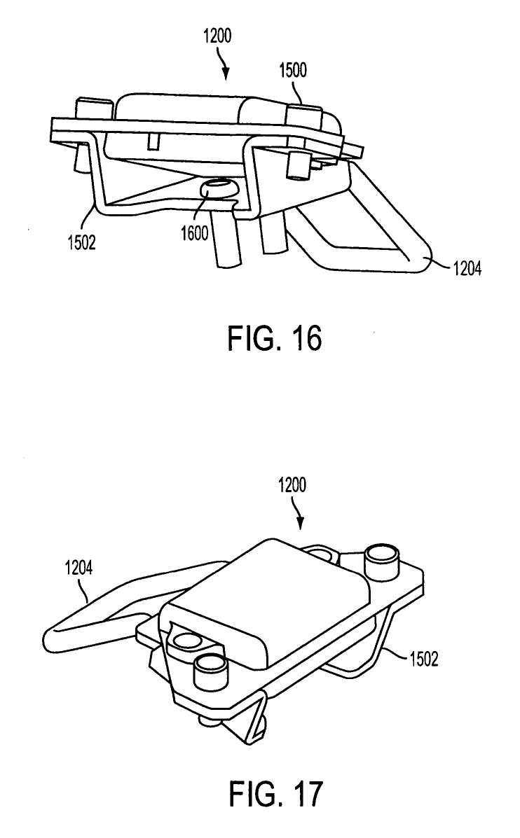

FIG. 15 is a perspective view of the assembly 1200 mounted to the fixed seat structure 802 via fasteners 1500 and a mounting bracket 1502. The mounting bracket 1502 may be configured in a manner similar to the mounting bracket 1100 illustrated in FIG. 11 and may be secured to the structure 802 via fasteners 1600, as shown in FIG. 16. FIG. 17 is a top perspective view of the assembly 1200 mounted to the bracket 1502.

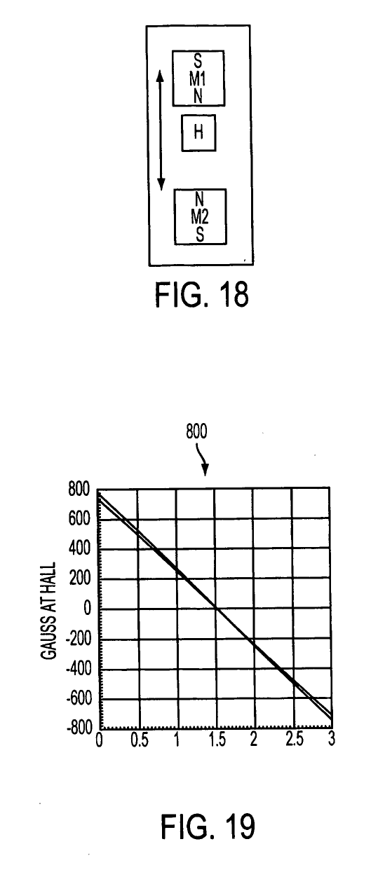

Turning now to FIG. 18, a sensor consistent with the invention may include magnets M1, M2, e.g. magnets 920, 922 or 1206, 1208, disposed in a relationship to the Hall effect device H, e.g. on the PCB 916, 1226. Advantageously, one of the magnets M1 may be positioned with a north pole facing the Hall device H and the other magnet M2 may be positioned opposing the first magnet with a north pole facing the Hall device, as shown. In one embodiment, the magnets may be spaced by distance of 10 millimeters and the Hall device may be disposed about 2 millimeters from a magnet face. This configuration provides a high gradient magnetic circuit that reduces sensitivity to magnetic fields generated outside of the sensor, e.g. in a speaker. For example, a gradient of 1500 Gauss may be applied to the Hall Effect device through the range of motion of the bar.

This configuration also provides small output voltage variance within large manufacturing tolerances. For example, FIG. 8 is a plot 800 of magnetic flux versus distance of travel of the magnets M1, M2 relative to the Hall device H. In the illustrated exemplary embodiment, a gradient of about 1500 Gauss is associated with movement of about 3 millimeters of the magnets M1, M2 relative to the Hall device H.

Also, for an analog sensor, calibration of the Hall device to provide an output indicative of the level of tension on the bar can be achieved prior to installation of the sensor in the seat system. In one embodiment, for example, calibration can be achieved by setting the Hall device H to provide a 1 volt output at a rest position of the sensor, then setting the Hall device to a 4 volt output with the bar pulled at the desired maximum load requirement, e.g. 60N. With this calibration, Hall device may provide a discreet output between 1V and 4V depending on the level of tension on the bar. There is thus provided a sensor assembly that reliably provides an output representative of the level of tension imparted as a child seat is attached to the bar in an automobile.

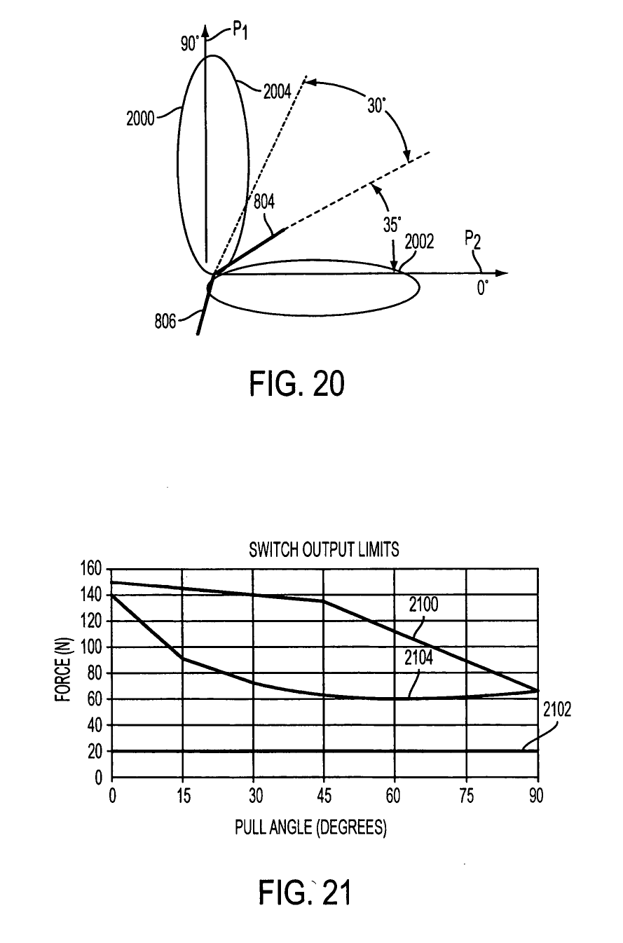

FIG. 20 is a schematic illustration of a sensor consistent with the invention mounted in relationship to a vehicle seat 2000. As shown, the sensor is mounted so that the bar 804 extends outward between the seat portion 2002 and the back portion 2004 of the seat assembly 2000. The sensor body portion 806 extends between the seat back and seat cushion for mounting to the fixed structure, e.g. structure 802.

FIG. 21 is a plot of force versus pull angle associated with an exemplary sensor consistent with the invention. A pull angle of 90 degrees is illustrated by arrow P1, and a pull angle of 0 degrees is illustrated by arrow P2 in FIG. 20. Plot 2100 is associated with an upper switch point limit and plot 2102 is associated with a lower switch point limit. The area between plots 2100 and 2102 may be a required switch zone in a particular embodiment. Plot 2104 illustrates the switch output limits associated with a sensor consistent with the present invention.

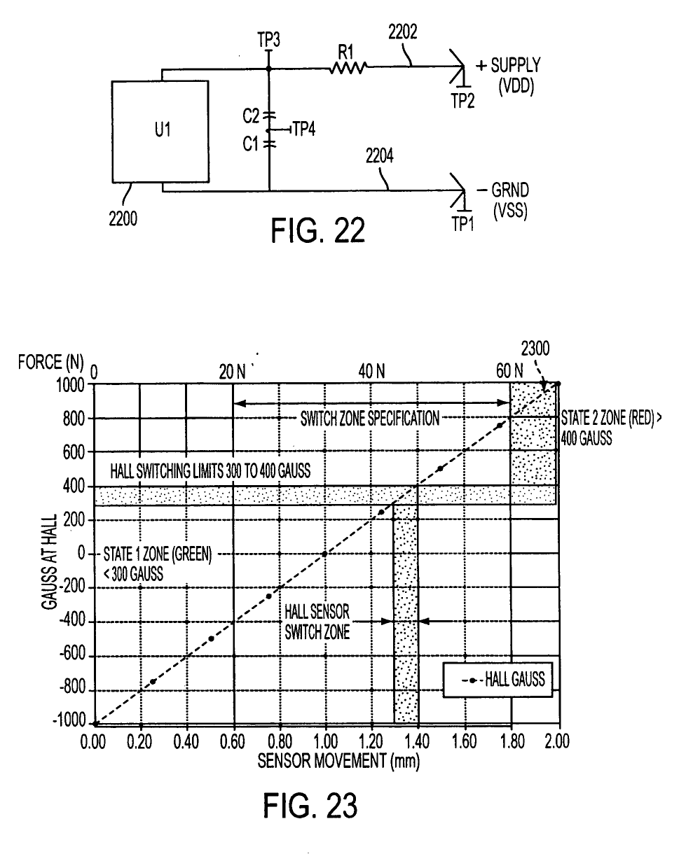

FIG. 22 is a circuit diagram of an exemplary digital sensor switch design including a digital Hall IC 2200. The supply input is provided on lead 2202 to R1 and the circuit output is provided at lead 2204. In a first state of the sensor wherein low magnetic fields are imparted to the Hall IC 2200, e.g. under a force of 0-20 N applied to the bar, and output current of 5 to 7 milliamps may be provided in one embodiment. In a second state, e.g. where the force applied to the bar is greater than 60 N, a high magnetic field may be imparted to the Hall IC and a current output of 12-17 milliamps may be provided by the circuit. Of course, those of ordinary skill in the art will recognize that the current output may be modified to meet the requirements of a particular application.

FIG. 23 is a plot 2300 of Gauss versus sensor movement for a digital IC. In the illustrative plot, the sensor assembly may be configured to provide a first output when the force on the bar is between 0 and 20 N, as indicated by state one zone in FIG. 23. A second output may be provided when the force on the bar exceeds for example 60 N, indicated by state 2 zone in FIG. 23.

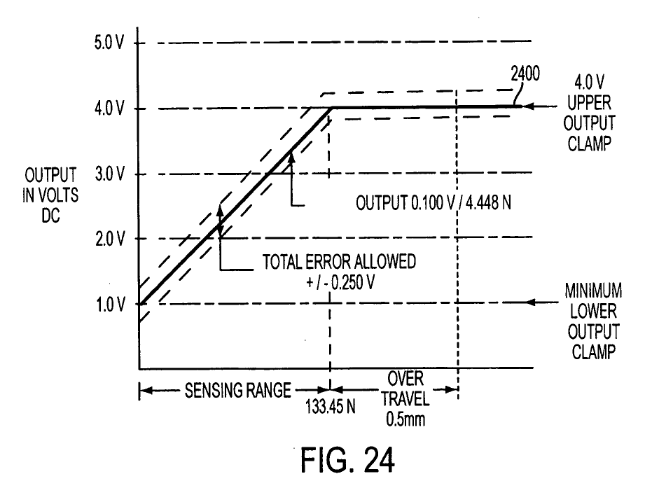

FIG. 24 is a plot 2400 of outputs in Volts DC versus sensor movement associated with an analog tension switch design. This may be a 3 wire design also known as a ratiometric linear sensor design. The digital tension sensor embodiment may be a 2 wire design, also known as a current loop design. As shown in FIG. 24, the analog Hall sensor design provides an output that is linearly related to sensor movement over a sensing range. Also, the output may include an upper limit, e.g. 4 Volts.

There is thus provided a child safety seat sensor system and method that provides reliable attachment and detection of a child safety seat or other device to a vehicle. The sensor may include an enclosed solid state Hall (switch or linear; programmable) that provides a digital or analog output operating in difficult environmental conditions for the life of the vehicle. The Hall device may be mounted on a PCB that may be in a sealed cavity. Sealing can be obtained by a perimeter seal, grommet, o-ring, or epoxy or by ultra sonic welding or over-molding. The device may allow for diagnostic capability, and may be modular, allowing modification of one or more components, e.g. the Hall device, magnets, springs, etc. to achieve desired performance. In addition, the design may allow for flexibility in the desired sensor travel and the load vs. output requirements. Travel between 1 and 3 mm can easily be achieved by modification of the dimensions of the bar assembly and main plate, or by calibration of the magnetic circuit. The sensor may be usable with any type of tether or latching clevis without the need for any adaptations, e.g. one sensor for all tethers, and is adaptable to a variety of mounting configurations. The sensor may also have a low profile and be robust to external magnetic fields.

The embodiments that have been described herein, however, are but some of the several which utilize this invention and are set forth here by way of illustration but not of limitation. Additionally, it will be appreciated that aspects of the various embodiments may be combined in other embodiments. It is obvious that many other embodiments, which will be readily apparent to those skilled in the art, may be made without departing materially from the spirit and scope of the invention as defined in the appended claims.

What is claimed is:

1. A child safety seat sensor system comprising:
a main plate configured for attachment to a fixed vehicle structure;
a movable member having a portion at least partially disposed in an opening in said main plate, said movable member comprising connection bar extending beyond said main plate for receiving an attachment mechanism fixed to said child safety seat;
at least one magnet fixed to said movable member; and
a Hall device disposed adjacent said magnet and fixed to said main plate, whereby tension on said bar causes relative motion between said at least one magnet in said Hall device;
said Hall device providing a first output upon application of tension to said bar and a second output when tension is removed from said bar.

2. A sensor assembly according to claim 1, wherein said connection bar includes angularly disposed relative to said main plate.

3. A sensor assembly according to claim 1, wherein said assembly further comprises at least one spring for biasing said movable member in a first position relative to said main plate.
